(19) United States
(12) Patent Application Publication
(10) Pub. No.: US 2015/0291222 A1
(43) Pub. Date: Oct. 15, 2015

(54) ELASTICALLY AVERAGED ALIGNMENT SYSTEMS AND METHODS

(71) Applicant: GM GLOBAL TECHNOLOGY OPERATIONS LLC, Detroit, MI (US)

(72) Inventors: Joel Colombo, Howell, MI (US); Catherine A. Ostrander, Grand Blanc, MI (US)

(73) Assignee: GM GLOBAL TECHNOLOGY OPERATIONS LLC., Detroit, MI (US)

(21) Appl. No.: 14/249,746

(22) Filed: Apr. 10, 2014

(51) Int. Cl. B62D 27/02; B60Q 1/04; B62D 27/06

(52) U.S. Cl. CPC B62D 27/02; B62D 27/06; B60Q 1/04

(57) ABSTRACT

In one aspect, an elastically averaged alignment system is provided. The system includes a first component having a plurality of opposed alignment members, the plurality of opposed alignment members defining a channel therebetween, and a second component configured for insertion into the channel between the plurality of opposed alignment members. At least one of the plurality of opposed alignment members and the second component is an elastically deformable material such that when the second component is inserted into the channel, at least one of the plurality of opposed alignment members and the second component elastically deform to an elastically averaged final configuration to facilitate aligning the first component and the second component in a desired orientation.

### FIELD OF THE INVENTION

The subject invention relates to matable components and, more specifically, to elastically averaged matable components for precise alignment therebetween.

### BACKGROUND

Components, in particular vehicular components used in automotive vehicles, which are to be mated together in a manufacturing process may be mutually located with respect to each other by alignment features that are oversized holes and/or undersized upstanding bosses. Such alignment features are typically sized to provide spacing to freely move the components relative to one another to align them without creating an interference therebetween that would hinder the manufacturing process. One such example includes two-way and/or four-way male alignment features; typically upstanding bosses, which are received into corresponding female alignment features, typically apertures in the form of slots or holes. The components are formed with a predetermined clearance between the male alignment features and their respective female alignment features to match anticipated size and positional variation tolerances of the male and female alignment features that result from manufacturing (or fabrication) variances.

As a result, significant positional variation can occur between two mated components having the aforementioned alignment features, which may contribute to the presence of undesirably large variation in their alignment, particularly with regard to gaps and/or spacing therebetween. In the case where misaligned components are also part of another assembly, such misalignment may also affect the function and/or aesthetic appearance of the entire assembly. Regardless of whether such misalignment is limited to two components or an entire assembly, it can negatively affect function and result in a perception of poor quality. Moreover, clearance between misaligned components may lead to relative motion therebetween, which may cause undesirable noise such as squeaking, and rattling.

### SUMMARY OF THE INVENTION

In one aspect, an elastically averaged alignment system is provided. The system includes a first component having a plurality of opposed alignment members, the plurality of opposed alignment members defining a channel therebetween, and a second component configured for insertion into the channel between the plurality of opposed alignment members. At least one of the plurality of opposed alignment members and the second component is an elastically deformable material such that when the second component is inserted into the channel, at least one of the plurality of opposed alignment members and the second component elastically deform to an elastically averaged final configuration to facilitate aligning the first component and the second component in a desired orientation.

In another aspect, a vehicle is provided. The vehicle includes a body and an elastically averaged alignment system integrally arranged within the body. The elastically averaged alignment system includes a first component having a plurality of opposed alignment members, the plurality of opposed alignment members defining a channel therebetween, and a second component configured for insertion into the channel between the plurality of opposed alignment members. At least one of the plurality of opposed alignment members and the second component is an elastically deformable material such that when the second component is inserted into the channel, at least one of the plurality of opposed alignment members and the second component elastically deform to an elastically averaged final configuration to facilitate aligning the first component and the second component in a desired orientation

In yet another aspect, a method of manufacturing an elastically averaged alignment system is provided. The method includes forming a first component comprising a plurality of opposed alignment members, the plurality of opposed alignment members defining a channel therebetween, forming a second component configured for insertion into the channel between the plurality of opposed alignment members, and fabricating at least one of the plurality of opposed alignment members and the second component from an elastically deformable material. The elastically deformable material is such that when the second component is inserted into the channel, at least one of the plurality of opposed alignment members and the second component elastically deform to an elastically averaged final configuration to facilitate aligning the first component and the second component in a desired orientation.

The above features and advantages and other features and advantages of the invention are readily apparent from the following detailed description of the invention when taken in connection with the accompanying drawings.

### BRIEF DESCRIPTION OF THE DRAWINGS

Other features, advantages and details appear, by way of example only, in the following detailed description of embodiments, the detailed description referring to the drawings in which:

FIG. 1 is a perspective view of an exemplary elastic averaging alignment system before assembly;

FIG. 2 is a perspective view of the system shown in FIG. 1 and after assembly;

FIG. 3 is a cross-sectional view of the system shown in FIG. 2 and taken along line 3-3;

FIG. 4 is a plan view of the system shown in FIG. 2;

FIG. 5 is a side view of a vehicle including the elastically averaged alignment system shown in FIGS. 1-4; and

FIG. 6 is an disassembled view of an exemplary elastic averaging alignment system that may be used in the vehicle shown in FIG. 5.

### DETAILED DESCRIPTION

The following description is merely exemplary in nature and is not intended to limit the present disclosure, its application or uses. For example, the embodiments shown are applicable to vehicle components, but the system disclosed herein may be used with any suitable components to provide securement and elastic averaging for precision location and alignment of all manner of mating components and component applications, including many industrial, consumer product (e.g., consumer electronics, various appliances and the like), transportation, energy and aerospace applications, and particularly including many other types of vehicular components and applications, such as various interior, exterior, electrical and under hood vehicular components and applications. It should be understood that throughout the drawings, corresponding reference numerals indicate like or corresponding parts and features.

As used herein, the term “elastically deformable” refers to components, or portions of components, including component features, comprising materials having a generally elastic deformation characteristic, wherein the material is configured to undergo a resiliently reversible change in its shape, size, or both, in response to the application of a force. The force causing the resiliently reversible or elastic deformation of the material may include a tensile, compressive, shear, bending or torsional force, or various combinations of these forces. The elastically deformable materials may exhibit linear elastic deformation, for example that described according to Hooke's law, or non-linear elastic deformation.

Elastic averaging provides elastic deformation of the interface(s) between mated components, wherein the average deformation provides a precise alignment, the manufacturing positional variance being minimized to Xₘᵢₙ, defined by Xₘᵢₙ=X/√N, wherein X is the manufacturing positional variance of the locating features of the mated components and N is the number of locating features. To obtain elastic averaging, an elastically deformable component is configured to have at least one feature and its contact surface(s) that is over-constrained and provides an interference fit with a mating feature of another component and its contact surface(s). The over-constrained condition and interference fit resiliently reversibly (elastically) deforms at least one of the at least one feature or the mating feature, or both features. The resiliently reversible nature of these features of the components allows repeatable insertion and withdrawal of the components that facilitates their assembly and disassembly. Positional variance of the components may result in varying forces being applied over regions of the contact surfaces that are over-constrained and engaged during insertion of the component in an interference condition. It is to be appreciated that a single inserted component may be elastically averaged with respect to a length of the perimeter of the component. The principles of elastic averaging are described in detail in commonly owned, co-pending U.S. patent application Ser. No. 13/187,675, published as U.S. Pub. No. 2013/0019455, the disclosure of which is incorporated by reference herein in its entirety. The embodiments disclosed above provide the ability to convert an existing component that is not compatible with the above-described elastic averaging principles, or that would be further aided with the inclusion of a four-way elastic averaging system as herein disclosed, to an assembly that does facilitate elastic averaging and the benefits associated therewith.

Any suitable elastically deformable material may be used for the mating components and alignment features disclosed herein and discussed further below, particularly those materials that are elastically deformable when formed into the features described herein. This includes various metals, polymers, ceramics, inorganic materials or glasses, or composites of any of the aforementioned materials, or any other combinations thereof suitable for a purpose disclosed herein. Many composite materials are envisioned, including various filled polymers, including glass, ceramic, metal and inorganic material filled polymers, particularly glass, metal, ceramic, inorganic or carbon fiber filled polymers. Any suitable filler morphology may be employed, including all shapes and sizes of particulates or fibers. More particularly any suitable type of fiber may be used, including continuous and discontinuous fibers, woven and unwoven cloths, felts or tows, or a combination thereof. Any suitable metal may be used, including various grades and alloys of steel, cast iron, aluminum, magnesium or titanium, or composites thereof, or any other combinations thereof. Polymers may include both thermoplastic polymers or thermoset polymers, or composites thereof, or any other combinations thereof, including a wide variety of co-polymers and polymer blends. In one embodiment, a preferred plastic material is one having elastic properties so as to deform elastically without fracture, as for example, a material comprising an acrylonitrile butadiene styrene (ABS) polymer, and more particularly a polycarbonate ABS polymer blend (PC/ABS). The material may be in any form and formed or manufactured by any suitable process, including stamped or formed metal, composite or other sheets, forgings, extruded parts, pressed parts, castings, or molded parts and the like, to include the deformable features described herein. The elastically deformable alignment features and associated component may be formed in any suitable manner. For example, the elastically deformable alignment features and the associated component may be integrally formed, or they may be formed entirely separately and subsequently attached together. When integrally formed, they may be formed as a single part from a plastic injection molding machine, for example. When formed separately, they may be formed from different materials to provide a predetermined elastic response characteristic, for example. The material, or materials, may be selected to provide a predetermined elastic response characteristic of any or all of the elastically deformable alignment features, the associated component, or the mating component. The predetermined elastic response characteristic may include, for example, a predetermined elastic modulus.

As used herein, the term vehicle is not limited to just an automobile, truck, van or sport utility vehicle, but includes any self-propelled or towed conveyance suitable for transporting a burden.

Described herein are elastic averaging alignment systems and methods. The alignment systems include a first component with a plurality of alignment members, and a second component that is inserted between the alignment members. The alignment members and/or the second component elastically deforms to facilitate precisely aligning and the two components together in a desired orientation.

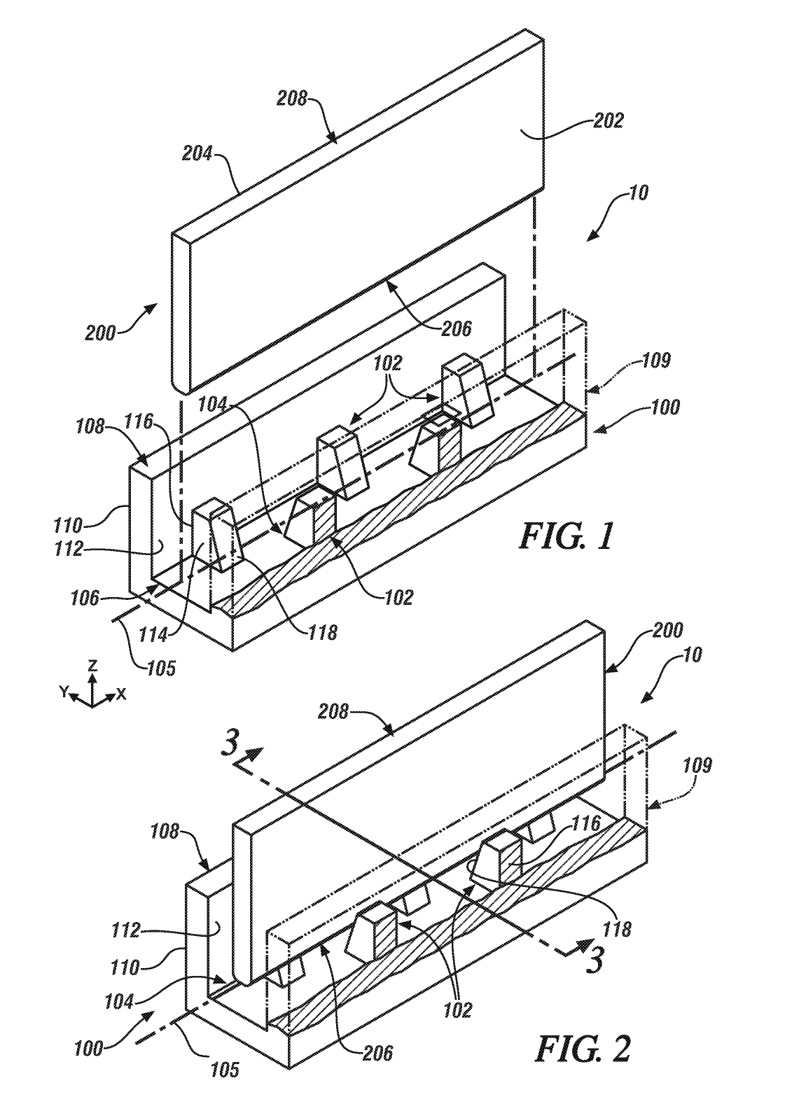

FIGS. 1-4 illustrate an exemplary elastically averaged alignment system 10 that generally includes a first component 100 to be mated to a second component 200. In the exemplary embodiment, first component 100 includes a plurality of alignment members 102 oriented to define a channel 104 between opposed alignment members 102 to receive second component 200. Alignment members 102 are fixedly disposed on or formed integrally with first component 100 for proper alignment and orientation when components 100 and 200 are mated. Although five alignment members 102 are illustrated, components 100 may have any number and combination of alignment members 102.

In the exemplary embodiment, second component 200 is an elastically deformable material and is configured and disposed to interferingly, deformably, and matingly engage alignment members 102, as discussed herein in more detail, to precisely align first component 100 with second component 200 in two or four directions, such as the +/−x-direction and the +/−y-direction of an orthogonal coordinate system, for example, which is herein referred to as two-way and four-way alignment. Moreover, elastically deformable second component 200 matingly engages alignment members 102 to facilitate a stiff and rigid connection between first component 100 and second component 200, thereby reducing or preventing relative movement therebetween

In the exemplary embodiment, first component 100 generally includes a base 106, opposed sidewalls 108 and 109 coupled to base 106, an outer surface 110, and an inner face 112 from which alignment members 102 extend. Alignment members 102 define channel 104 therebetween that includes a channel axis 105, and opposed sidewalls 108, 109 may also at least partially define channel 104. Alternatively, first component 100 may not include sidewalls 108 and/or 109. In the exemplary embodiment, first component 100 is fabricated from a rigid material such as plastic. However, first component 100 may be fabricated from any suitable material that enables system 10 to function as described herein. Moreover, alignment members 102 may be fabricated from an elastically deformable material.

Each alignment member 102 has a trapezoidal shape and includes a first wall 114 coupled to base 106, a second wall 116 coupled (if present) to one sidewall 108, 109, and, in the exemplary embodiment, a ramped wall 118. However, alignment members 102 may have any suitable shape that enables system 10 to function as described herein. For example, each alignment member may be rectangular and not include a ramped wall. As best shown in FIG. 4, alignment members 102 are oriented in a staggered formation along channel 104. Alternatively, a pair of alignment members 102 may be oriented directly across from each other. Moreover, in an embodiment, alignment members 102 alternate between either side of channel 104 extending along axis 105 (e.g., alternate between sidewall 108 and opposed sidewall 109). However, first component 100 may be formed with alignment members 102 oriented in other suitable configurations that enable system 10 to function as described herein. For example, extending along axis 105, two alignment members 102 may be oriented along sidewall 108 before alternating to two alignment members 102 oriented along sidewall 109.

Second component 200 generally includes an outer face 202, an inner face 204, and opposed ends 206 and 208. Although illustrated as rectangular in shape, second component 200 may have any shape that enables system 10 to function as described herein. In the exemplary embodiment, second component 200 is fabricated from an elastically deformable material. However, second component 200 may be fabricated from any suitable material that enables system 10 to function as described herein. For example, alignment members 102 may be fabricated from an elastically deformable material and second component 200 may be fabricated from a rigid material such as plastic.

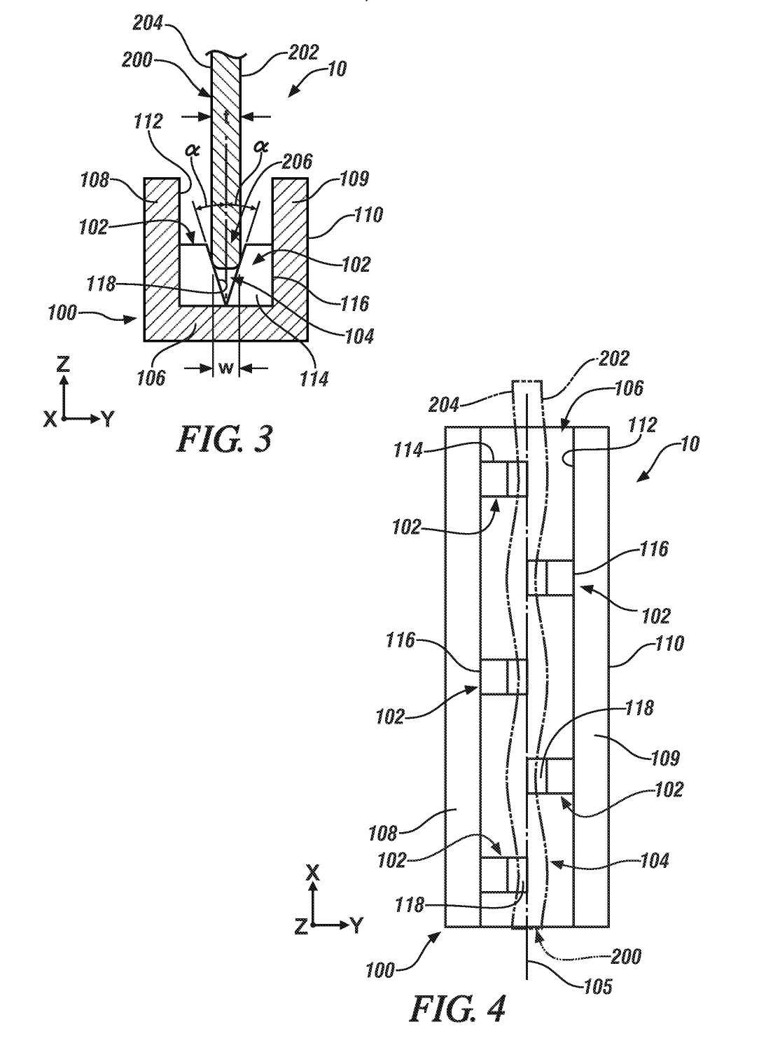

To provide an arrangement where elastically deformable second component 200 is configured and disposed to interferingly, deformably and matingly engage the plurality of opposed alignment members 102, a width “w” (FIG. 3) of channel 104 or distance between opposed alignment members 102 is smaller than a thickness “t” or cross-section of second component 200, which necessarily creates a purposeful interference fit between the elastically deformable second component 200 and opposed alignment members 102. As such, when second component end 206 is inserted into channel 104 between alignment members 102, portions of the elastically deformable second component 200 elastically deform to an elastically averaged final configuration that aligns second component 200 with first component 100 in at least two planar orthogonal directions (e.g., the +/−x-direction and the +/−y-direction).

In an exemplary embodiment, portion 118 of alignment members 102 are ramped or angled to provide an interference with second component 200 that facilitates a predetermined force to insert second component 200 into channel 104. As best shown in FIG. 3, in the exemplary embodiment, ramped walls 118 are ramped or angled at an angle “α”. As such, opposed walls 118 converge as they extend toward first component base 106. Angle “α” may be variably designed such that a predetermined force will be required to insert second component 200 into channel 104 between opposed alignment members 102. For example, as angle “α” is increased, the force required for second component insertion is increased, and vice versa. In the exemplary embodiment, angle “α” may be any suitable angle that enables system 10 to function as described herein.

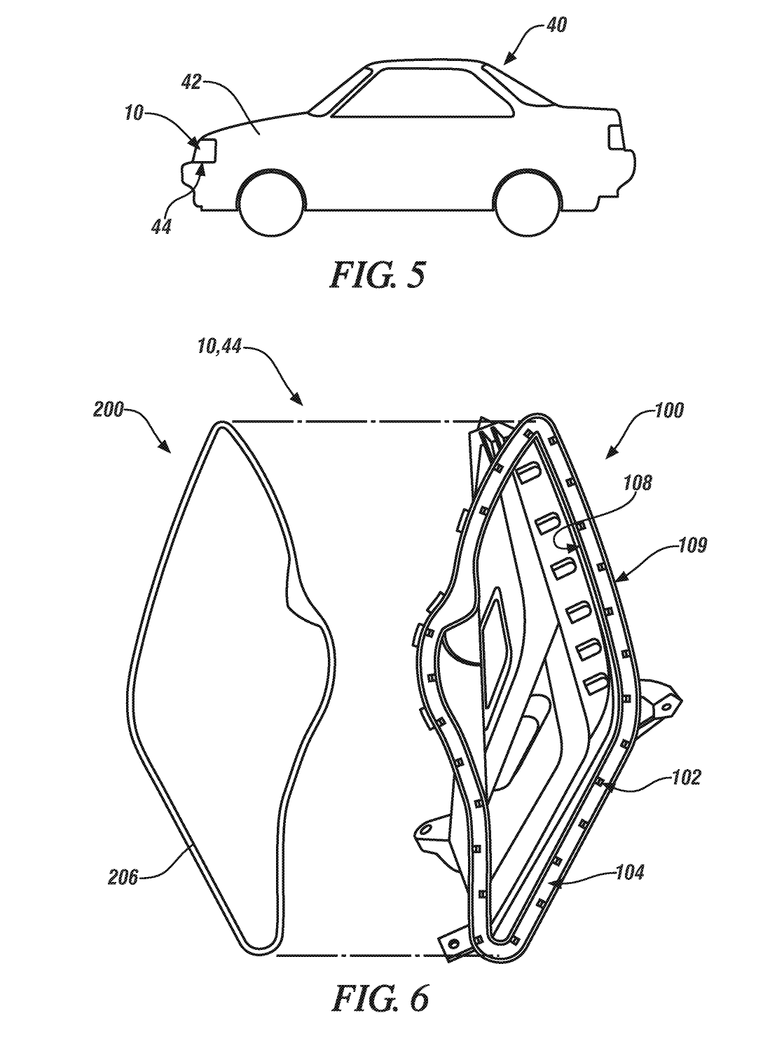

In view of the foregoing, and with reference now to FIG. 5, it will be appreciated that an embodiment of the invention also includes a vehicle 40 having a body 42 with an elastically averaging alignment system 10 as herein disclosed integrally arranged with the body 42. In the embodiment of FIG. 5, elastically averaging alignment system 10 is depicted forming at least a portion of a front headlight assembly 44 of the vehicle 40. As shown in FIG. 6, headlight assembly 44 may include second component 200 as a vehicle headlamp lens, and first component 100 as a supporting substructure that is part of, or is attached to, the vehicle and on which first component 100 is fixedly mounted in precise alignment. For example, first component 100 may be a portion of a vehicle headlamp housing. However, it is contemplated that an elastically averaging alignment system 10 as herein disclosed may be utilized with other structural features of the vehicle 40, such as interior trim and non-visible components like electrical module housings, instrument panel retainers, and console structure.

An exemplary method of fabricating elastically averaged alignment system 10 includes forming first component 100 with a plurality of opposed alignment members 102 defining channel 104, and forming second component 200 configured for insertion into channel 104. At least one of the plurality of alignment members 102 and second component 200 are fabricated from an elastically deformable material such that when second component 200 is inserted into channel 104, at least one of the plurality of alignment members 102 and second component 200 elastically deform to an elastically averaged final configuration to facilitate aligning first component 100 and second component 200 in a desired orientation. First component 100 is formed with base 106 and may also be formed with opposed sidewalls 108, 109. Alignment members 102 may be formed with ramped walls 118, and alignment members 102 may be staggered along channel 104 alternating between either side of channel axis 105.

Systems and methods for elastically averaging mating and alignment systems are described herein. The systems generally include a first component with a plurality of opposed alignment members at least partially defining a channel therebetween. An elastically deformable second component is positioned for insertion into the channel. The mating of the first and second components is elastically averaged over the plurality of alignment members to precisely mate the components in a desired orientation. Accordingly, the described systems and methods facilitate precise alignment of two or more components in a desired orientation.

While the invention has been described with reference to exemplary embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiments disclosed, but that the invention will include all embodiments falling within the scope of the application.

What is claimed is:

1. An elastically averaged alignment system comprising:
a first component comprising a plurality of opposed alignment members, the plurality of opposed alignment members defining a channel therebetween; and
a second component configured for insertion into the channel between the plurality of opposed alignment members,
wherein at least one of the plurality of opposed alignment members and the second component is an elastically deformable material such that when the second component is inserted into the channel, at least one of the plurality of opposed alignment members and the second component elastically deform to an elastically averaged final configuration to facilitate aligning the first component and the second component in a desired orientation.

2. The system of claim 1, wherein the alignment members of the plurality of opposed alignment members are staggered along the channel.

3. The system of claim 1, wherein the alignment members of the plurality of opposed alignment are located alternately between a first side of the channel and an opposite, second side of the channel.

4. The system of claim 1, wherein each alignment member of the plurality of alignment members includes a ramped surface, at least one of the plurality of opposed alignment members and the second component elastically deform when the second component is inserted into the channel and contacts the ramped surface of each alignment member.

5. The system of claim 1, wherein the first component further comprises a pair of opposed walls further defining the channel.

6. The system of claim 1, wherein the first component is a headlamp housing and the second component is a headlamp lens.

7. A vehicle comprising:
a body; and
an elastically averaged alignment system integrally arranged within the body, the elastically averaged alignment system comprising:
a first component comprising a plurality of opposed alignment members, the plurality of opposed alignment members defining a channel therebetween; and
a second component configured for insertion into the channel between the plurality of opposed alignment members,
wherein at least one of the plurality of opposed alignment members and the second component is an elastically deformable material such that when the second component is inserted into the channel, at least one of the plurality of opposed alignment members and the second component elastically deform to an elastically averaged final configuration to facilitate aligning the first component and the second component in a desired orientation.

8. The vehicle of claim 7, wherein the alignment members of the plurality of opposed alignment members are staggered along the channel.

9. The vehicle of claim 7, wherein the alignment members of the plurality of opposed alignment are located alternately between a first side of the channel and an opposite, second side of the channel.

10. The vehicle of claim 7, wherein each alignment member of the plurality of alignment members includes a ramped surface, at least one of the plurality of opposed alignment members and the second component elastically deform when the second component is inserted into the channel and contacts the ramped surface of each alignment member.

11. The vehicle of claim 7, wherein the first component further comprises a pair of opposed walls further defining the channel.

12. The vehicle of claim 7, wherein the first component is a headlamp housing and the second component is a headlamp lens.

13. A method of manufacturing an elastically averaged alignment system, the method comprising:
forming a first component comprising a plurality of opposed alignment members, the plurality of opposed alignment members defining a channel therebetween;
forming a second component configured for insertion into the channel between the plurality of opposed alignment members; and
fabricating at least one of the plurality of opposed alignment members and the second component from an elastically deformable material such that when the second component is inserted into the channel, at least one of the plurality of opposed alignment members and the second component elastically deform to an elastically averaged final configuration to facilitate aligning the first component and the second component in a desired orientation.

14. The method of claim 13, further comprising orienting the alignment members of the plurality of opposed alignment members to be staggered along the channel.

15. The method of claim 13, further comprising locating the alignment members of the plurality of opposed alignment members alternately between a first side of the channel and an opposite, second side of the channel.

16. The method of claim 13, further comprising forming each alignment member of the plurality of alignment members to include a ramped surface, wherein at least one of the plurality of opposed alignment members and the second component elastically deform when the second component is inserted into the channel and contacts the ramped surface of each alignment member.

17. The method of claim 13, further comprising forming the first component to include a pair of opposed walls further defining the channel.

18. The method of claim 13, further comprising forming the first component as a headlamp housing and forming the second component as a headlamp lens.
